(19) United States
(12) Patent Application Publication
(10) Pub. No.: US 2026/0366775 A1
(43) Pub. Date: Nov. 19, 2026

(54) PRESSURE ACCUMULATOR FOR HVAC&R SYSTEM

(71) Applicant: Tyco Fire & Security GmbH, Neuhausen am Rheinfall (CH)

(72) Inventors: Bryson Lee Sheaffer, Mechanicsburg, PA (US); Sarah E. Hamilton, New Freedom, PA (US); Paul William Snell, York, PA (US)

(21) Appl. No.: 19/154,330

(22) PCT Filed: Feb. 7, 2024
(86) PCT No.: PCT/US2024/014809

§ 371 Date: Aug. 6, 2025

Related U.S. Application Data
(60) Provisional application No. 63/443,921, filed on Feb. 7, 2023.
(60) Provisional application No. 63/529,974, filed on Jul. 31, 2023.

(51) Int. Cl. F25B 31/00; F16N 7/38; F25B 43/00

(52) U.S. Cl. CPC F25B 31/002; F16N 7/38; F25B 43/006; F16N 2210/10; F16N 2260/24; F25B 2400/25; F25B 2500/16

(57) ABSTRACT

A heating, ventilation, air conditioning, and/or refrigeration (HVAC&R) system includes a compressor having a bearing. The HVAC&R system also includes a lubricant circuit configured to direct a flow of a fluid to the bearing. Additionally, the HVAC&R system includes a pressure accumulator fluidly coupled to the lubricant circuit upstream of the bearing. The pressure accumulator is configured to receive and contain a portion of the fluid from the lubricant circuit.

### CROSS-REFERENCE TO RELATED APPLICATIONS

This application claims priority from and the benefit of U.S. Provisional Application No. 63/529,974, entitled “PRESSURE ACCUMULATOR FOR HVAC&R SYSTEM,” filed Jul. 31, 2023, and U.S. Provisional Application No. 63/443,921, entitled “BEARING SYSTEM FOR HVAC&R SYSTEM,” filed Feb. 7, 2023, each of which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Chiller systems, or vapor compression systems, utilize a working fluid (e.g., a refrigerant) that changes phases between vapor, liquid, and combinations thereof in response to exposure to different temperatures and pressures within components of the chiller system. The chiller system may place the working fluid in a heat exchange relationship with a conditioning fluid (e.g., water) and may deliver the conditioning fluid to conditioning equipment and/or a conditioned environment serviced by the chiller system. In such applications, the conditioning fluid may be directed through downstream equipment, such as air handlers, to condition other fluids, such as air in a building. The chiller system may include a compressor configured to pressurize the working fluid and circulate the working fluid through a working fluid circuit of the chiller system. In some applications, a shaft of the compressor may be driven in rotation by a motor in order to drive rotation of an impeller of the compressor that pressurizes the working fluid. Traditionally, the compressor includes bearings configured to facilitate rotation of the shaft. Unfortunately, existing bearings utilized with compressors may be complex, expensive, and/or may contribute to inefficiencies in operation of the chiller system.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a heating, ventilation, air conditioning, and/or refrigeration (HVAC&R) system includes a compressor having a bearing. The HVAC&R system also includes a lubricant circuit configured to direct a flow of a fluid to the bearing. Additionally, the HVAC&R system includes a pressure accumulator fluidly coupled to the lubricant circuit upstream of the bearing. The pressure accumulator is configured to receive and contain a portion of the fluid from the lubricant circuit.

In another embodiment, a heating, ventilation, air conditioning, and/or refrigeration (HVAC&R) system includes a compressor having a bearing. The HVAC&R system also includes a conduit configured to direct a pressurized flow of a fluid to the bearing. Additionally, the HVAC&R system includes a pressure accumulator fluidly coupled to the conduit. The pressure accumulator is configured to apply a force to the fluid within the conduit based on a change in pressure of the fluid within the conduit.

In another embodiment, a heating, ventilation, air conditioning, and/or refrigeration (HVAC&R) system includes a compressor configured to pressurize a working fluid and circulate the working fluid through a working fluid circuit of the HVAC&R system. The compressor includes a bearing. The HVAC&R system includes a lubricant circuit extending from the working fluid circuit to the bearing. Additionally, the HVAC&R system includes a pump disposed along the working fluid circuit and configured to direct a portion of the working fluid to the bearing. Furthermore, the HVAC&R system includes a pressure accumulator fluidly coupled to the lubricant circuit. The pressure accumulator is configured to store a pressurized volume of the working fluid.

### DRAWINGS

Various aspects of this disclosure may be better understood upon reading the following detailed description and upon reference to the drawings in which:

FIG. 1 is a perspective view of an embodiment of a building that may utilize a heating, ventilating, air conditioning, and/or refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic of an embodiment of a vapor compression system, in accordance with an aspect of the present disclosure;

FIG. 4 is a schematic of an embodiment of a vapor compression system, in accordance with an aspect of the present disclosure;

FIG. 5 is a cross-sectional side view of an embodiment of a compressor of a vapor compression system, illustrating a bearing system of the compressor, in accordance with an aspect of the present disclosure;

FIG. 6 is a schematic of an embodiment of a vapor compression system including a bearing system for a compressor, in accordance with an aspect of the present disclosure;

FIG. 7 is a schematic of an embodiment of an accumulator for a bearing system, in accordance with an aspect of the present disclosure;

FIG. 8 is a schematic of an embodiment of an accumulator for a bearing system, in accordance with an aspect of the present disclosure;

FIG. 9 is a schematic of an embodiment of an accumulator for a bearing system, in accordance with an aspect of the present disclosure;

FIG. 10 is a schematic of an embodiment of an accumulator coupled to a fluid tank, in accordance with an aspect of the present disclosure; and

FIG. 11 is a schematic of an embodiment of an accumulator for a bearing system, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to mean that the given feature is within +/−5%, within +/−4%, within +/−3%, within +/−2%, within +/−1%, or even closer, to having the described nature, such as being parallel to another feature, being perpendicular to another feature, and so forth. Further, it should be understood that mathematical terms, such as “planar,” “slope,” “perpendicular,” “parallel,” and so forth are intended to encompass features of surfaces or elements as understood to one of ordinary skill in the relevant art, and should not be rigidly interpreted as might be understood in the mathematical arts. For example, a “planar” surface is intended to encompass a surface that is machined, molded, or otherwise formed to be substantially flat or smooth (within related tolerances) using techniques and tools available to one of ordinary skill in the art. Similarly, a surface having a “slope” is intended to encompass a surface that is machined, molded, or otherwise formed to be oriented at an angle (e.g., incline) with respect to a point of reference using techniques and tools available to one of ordinary skill in the art.

Embodiments of the present disclosure relate to a heating, ventilation, air conditioning, and refrigeration (HVAC&R) system (e.g., a chiller) including a vapor compression system (e.g., vapor compression circuit) having a compressor. In operation, the compressor may pressurize a working fluid within the vapor compression system and direct the working fluid to a condenser (e.g., a first heat exchanger), which may cool and condense the working fluid. The condensed working fluid may be directed to an expansion device, which may reduce a pressure of the working fluid, further cooling the working fluid. From the expansion device, the cooled working fluid may be directed to an evaporator (e.g., a second heat exchanger), where the working fluid may be placed in a heat exchange relationship with a conditioning fluid to cool the conditioning fluid. The conditioning fluid may be circulated between the evaporator and a structure, such as a building, where the conditioning fluid is used to cool an air flow delivered to a conditioned space of the structure. In some embodiments, an air handling unit (AHU) of the HVAC&R system may receive the conditioning fluid from the chiller and utilize the conditioning fluid to cool the air flow delivered to the conditioned space. The conditioning fluid may then be returned to the evaporator to be cooled again.

In some embodiments, the compressor may include a bearing system including bearings (e.g., hydrostatic bearings, porous bearings) that utilize a pressurized fluid to support and lubricate a rotating shaft of the compressor. For example, the bearing system may include a lubricant circuit extending from the working fluid circuit and direct a portion of the working fluid from the working fluid circuit into the bearings of the compressor. That is, the portion of the working fluid (e.g., refrigerant) in the lubricant circuit may be utilized as a lubricating fluid. The lubricant circuit may include a pump configured to pump the pressurized fluid toward the bearings of the compressor. In this way, the working fluid, which is configured to exchange heat with the conditioning fluid as part of the working fluid circuit, can also be utilized to lubricate the bearings and enable the bearings to support the shaft of the compressor. The pump may be configured to maintain a desired pressure of the pressurized fluid supplied to the bearings. Unfortunately, the supply of pressurized fluid to the bearings may be interrupted or otherwise hindered in some instances. For example, operation of the pump may be interrupted (e.g., by power loss), or the lubricant circuit may experience a pressure drop (e.g., due to conduit blockage or leakage), which may result in a decrease in the pressure of the pressurized fluid supplied to the bearings. As a result, operation of the compressor may be interrupted or restricted. In particular, the shaft may be inadequately supported and or inadequately lubricated, which may cause unintended operation, wear, and/or degradation on components of the bearing system, the shaft of the compressor, a motor of the compressor, and/or other components of the vapor compression system. That is, if operation of the pump is interrupted and the pressure of the pressurized fluid is not adequately sustained, the compressor may be vulnerable to wear and degradation caused by uncontrolled momentum, impact forces, and/or friction of the shaft. Therefore, improved compressors with bearing systems having more robust fluid supply systems are desired.

Accordingly, present embodiments are directed to a fluid supply system configured to at least temporarily maintain a pressure of pressurized fluid flowing to bearings of a compressor in the event of an interruption in normal operation of the fluid supply system. In particular, fluid supply systems described herein include a pressure accumulator configured to store the pressurized fluid (e.g., lubricating fluid) at a desired pressure during normal operation and discharge (e.g., dispense) the lubricating fluid toward the bearings (e.g., at the desired pressure) during an interruption in the normal operation. In this way, the pressure accumulator may function as a backup pressure source to temporarily continue supplying a pressurized flow of lubricating fluid to the bearings in the event of operational interruption of a pump or other component of the fluid supply system. Thus, the bearings may receive pressurized lubricating fluid until the pump is operable and/or until operation of the compressor is suspended in a controlled manner. In this way, present embodiments enable continued supply of the pressurized lubricating fluid to the bearings via operation of the pressure accumulator (e.g., and enable a controlled shutdown of the compressor, when appropriate) and enable mitigation of wear and degradation to components of the bearing system and compressor.

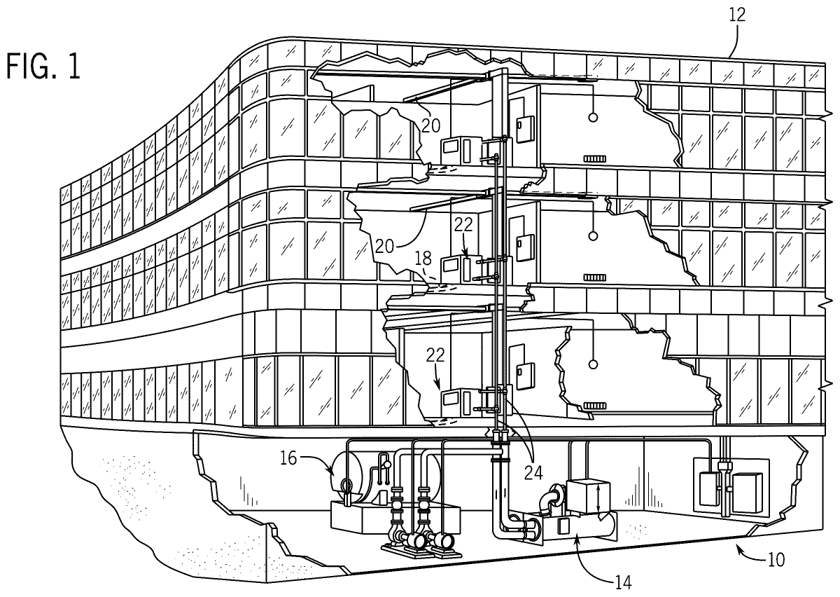

Turning now to the drawings, FIG. 1 is a perspective view of an embodiment of a heating, ventilating, air conditioning, and/or refrigeration (HVAC&R) system 10 in a building 12 for a typical commercial setting. The HVAC&R system may include a vapor compression system 14 to supply chilled liquid to cool the building 12 and a boiler 16 to supply warm liquid to heat the building 12. The vapor compression system 14, also referred to herein as a chiller, may circulate a working fluid (e.g., refrigerant) that is cooled by a cooling fluid (e.g., liquid such as water) in a condenser of the vapor compression system 14, and that is heated by a conditioning fluid (e.g., liquid, such as water) in an evaporator of the vapor compression system 14. The cooling fluid may be provided by a cooling tower which cools the cooling fluid via, for example, ambient air. The conditioning fluid, cooled by the working fluid as noted above, may be utilized to cool an air flow provided to conditioned spaces of the building 12.

The HVAC&R system 10 may also include an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or the conditioning fluid (e.g., chilled liquid such as water) from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors

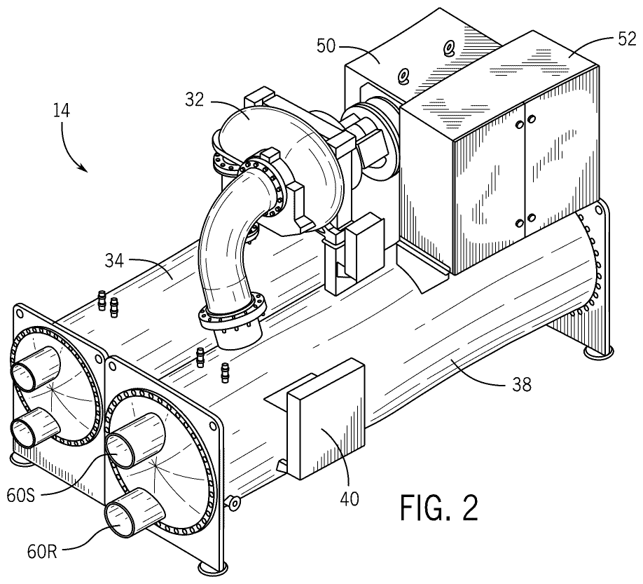

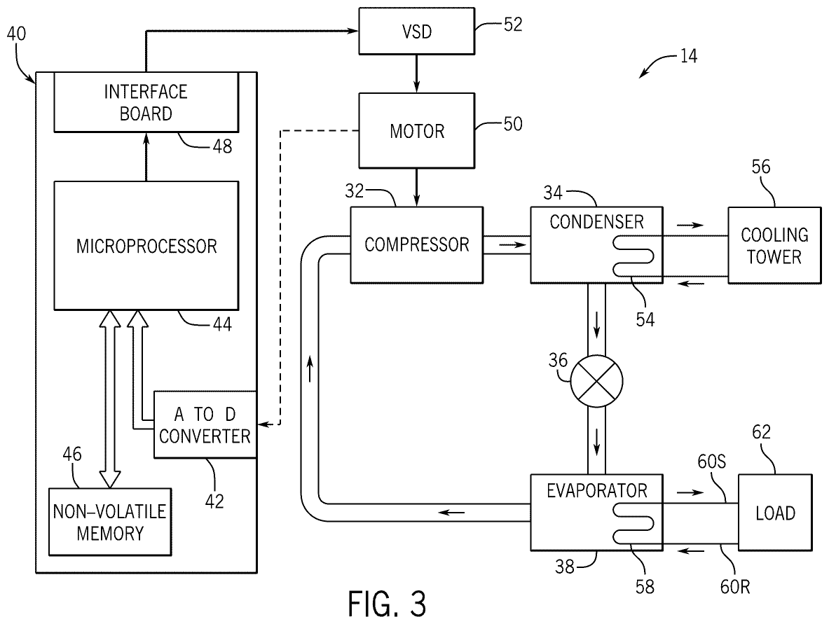

FIGS. 2 and 3 illustrate embodiments of the vapor compression system 14, or chiller, which can be used in the HVAC&R system 10. The vapor compression system 14 may circulate a working fluid through a circuit (e.g., working fluid circuit) starting with a compressor 32, such as a centrifugal compressor. The circuit may also include a condenser 34, an expansion valve(s) or device(s) 36, and an evaporator 38. The vapor compression system 14 may further include a control panel 40 that has an analog to digital (A/D) converter 42, a microprocessor 44, a non-volatile memory 46, and/or an interface board 48.

Some examples of fluids that may be used as working fluids in the vapor compression system 14 are hydrofluorocarbon (HFC) based refrigerants, for example, R-410A, R-407, R-134a, hydrofluoro olefin (HFO), “natural” refrigerants like ammonia (NH₃), R-717, carbon dioxide (CO₂), R-744, or hydrocarbon-based refrigerants, water vapor, or any other suitable working fluid. Other possible working fluids include R-123, R-514A, R-1130yd, R-1233zd, R-134a, R-1142ze, R-1142yf, R-1311, R-32, and R-410A. In some embodiments, the vapor compression system 14 may be configured to efficiently utilize working fluids having a normal boiling point of about 19 degrees Celsius (66 degrees Fahrenheit) at one atmosphere of pressure, also referred to as low pressure refrigerants, versus a medium pressure working fluid, such as R-134a. As used herein, “normal boiling point” may refer to a boiling point temperature measured at one atmosphere of pressure.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 during a normal operating mode and may be powered by a variable speed drive (VSD) 52. The VSD 52 receives alternating current (AC) power during the normal operating mode, where the AC power includes a particular fixed line voltage and fixed line frequency from an AC power source, and provides power having a variable voltage and frequency to the motor 50. In other embodiments, the motor 50 may be powered directly from an AC or direct current (DC) power source. The motor 50 may include any type of electric motor that can be powered by a VSD or directly from an AC or DC power source, such as a switched reluctance motor, an induction motor, an electronically commutated permanent magnet motor, or another suitable motor.

The compressor 32 compresses a working fluid vapor and delivers the vapor to the condenser 34 through a discharge passage. In some embodiments, the compressor 32 may be a centrifugal compressor. The working fluid vapor delivered by the compressor 32 to the condenser 34 may transfer heat to a cooling fluid (e.g., water or air) in the condenser 34. The working fluid vapor may condense to a working fluid liquid in the condenser 34 as a result of thermal heat transfer with the cooling fluid. The liquid working fluid from the condenser 34 may flow through the expansion device 36 to the evaporator 38. In the illustrated embodiment of FIG. 3, the condenser 34 is water cooled and includes a tube bundle 54 connected to a cooling tower 56, which supplies the cooling fluid to the condenser 34.

The liquid working fluid delivered to the evaporator 38 may absorb heat from a conditioning fluid that is subsequently routed to a load 62 (e.g., the building 12 of FIG. 1). For example, the conditioning fluid may be cooled by the working fluid in the evaporator 38, and then may be utilized in the building 12 of FIG. 1 to condition an air flow provided to condition a space in the building 12. The liquid working fluid in the evaporator 38 may undergo a phase change from the liquid working fluid to a working fluid vapor. As shown in the illustrated embodiment of FIG. 3, the evaporator 38 may include a tube bundle 58 having a supply line 60S and a return line 60R connected to the cooling load 62. The conditioning fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the conditioning fluid in the tube bundle 58 via thermal heat transfer with the working fluid. The tube bundle 58 in the evaporator 38 can include a plurality of tubes and/or a plurality of tube bundles. In any case, the vapor working fluid exits the evaporator 38 and returns to the compressor 32 by a suction line to complete the cycle.

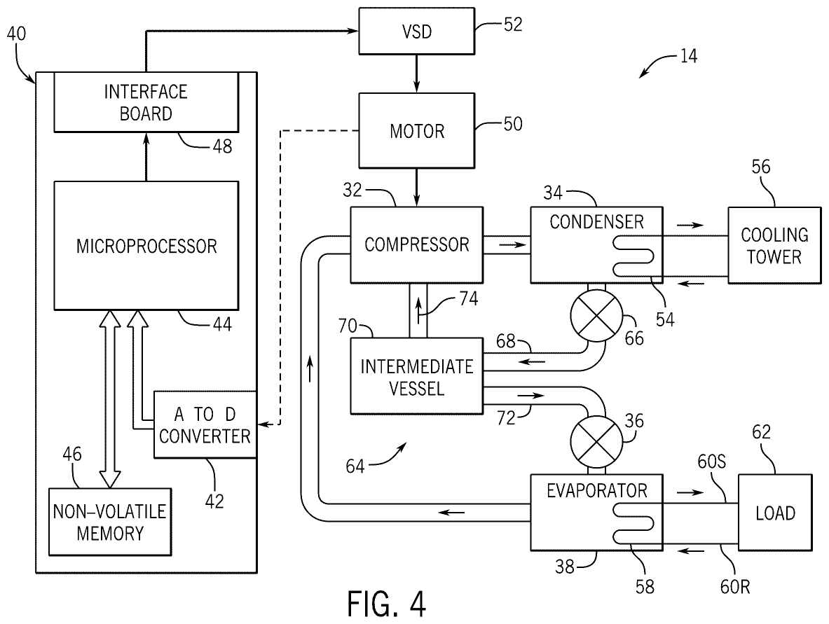

FIG. 4 is a schematic of an embodiment of the vapor compression system 14 with an intermediate circuit 64 incorporated between the condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the liquid working fluid received from the condenser 34. During the expansion process, a portion of the liquid working fluid may vaporize, and thus, the intermediate vessel 70 may be used to separate the vapor working fluid from the liquid working fluid received from the first expansion device 66. Additionally, the intermediate vessel 70 may provide for further expansion of the liquid working fluid due to a pressure drop experienced by the liquid working fluid when entering the intermediate vessel 70 (e.g., due to a rapid increase in volume experienced when entering the intermediate vessel 70). The vapor working fluid in the intermediate vessel 70 may be drawn by the compressor 32 through a suction line 74 of the compressor 32. In other embodiments, the vapor working fluid in the intermediate vessel 70 may be drawn to an intermediate stage of the compressor 32 (e.g., not the suction stage). The liquid working fluid that collects in the intermediate vessel 70 may be at a lower enthalpy than the liquid working fluid exiting the condenser 34 due to expansion of the working fluid at the expansion device 66 and/or in the intermediate vessel 70. The liquid working fluid from intermediate vessel 70 may then flow through line 72 and through a second expansion device 36 to the evaporator 38.

In accordance with present embodiments, the compressor 32 may be a centrifugal compressor (e.g., a hermetic compressor) having a levitated rotor or shaft. To this end, the vapor compression system 14 includes a bearing system with one or more bearings configured to support a load of the shaft of the compressor 32. The bearing system is configured to direct a pressurized fluid (e.g., liquid, working fluid, refrigerant) through the bearings, and the bearings are configured to discharge the fluid toward and against the shaft in order to enable levitation of the shaft within the compressor 32. Specifically, the bearings include one or more porous bearing elements configured to receive the pressurized fluid and direct the pressurized fluid toward the shaft within a housing of the compressor 32. In this way, the bearing system may support a load on the shaft and enable rotation of the shaft within the housing of the compressor 32 during operation of the vapor compression system 14. As discussed herein, the pressurized fluid may be a portion of a working fluid (e.g., refrigerant) circulated through the vapor compression system 14. Thus, the vapor compression system 14 may not utilize a dedicated lubricant, such as oil, to support and enable rotation of the shaft of the compressor 32. Further, the bearing system may be incorporated with the vapor compression system 14 at reduced costs, as compared to other existing bearing system designs. The disclosed embodiments also enable improved (e.g., simplified) control of the bearing system, as well as more efficient operation of the vapor compression system 14.

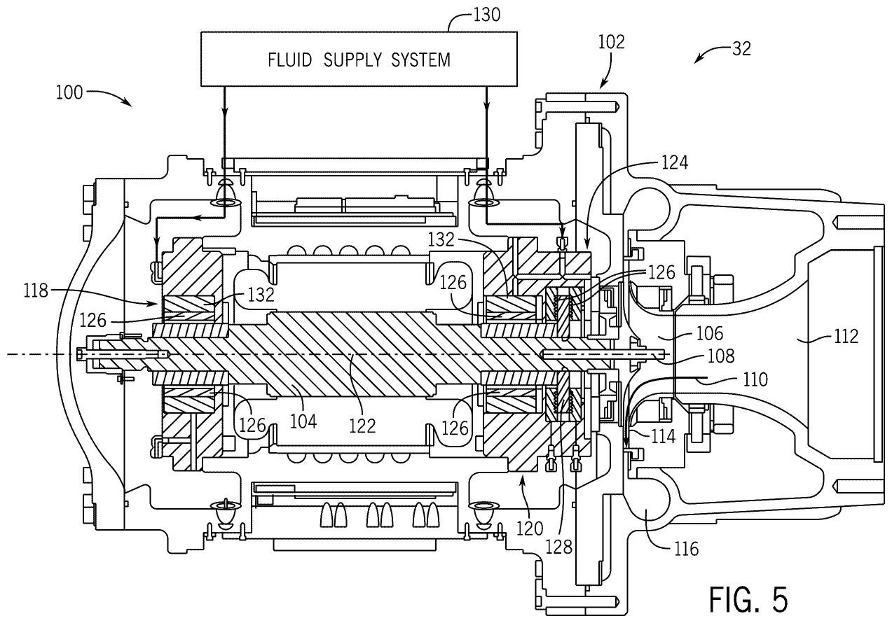

With the foregoing in mind, FIG. 5 is a cross-sectional side view of an embodiment of the compressor 32 including a bearing system 100, in accordance with aspects of the present disclosure. The compressor 32 may include a housing 102 and a shaft 104 extending through the housing 102. The compressor 32 may also include an impeller 106 coupled to the shaft 104, such as via a fastener 108. During operation of the compressor 32, the shaft 104 may rotate (e.g., via operation of the motor 50) and cause rotation of the impeller 106. Rotation of the impeller 106 may drive a working fluid (e.g., refrigerant) to flow through a working fluid flow path 110 (e.g., from the evaporator 38, from the intermediate vessel 70, working fluid circuit) to draw the working fluid into the housing 102 via a suction inlet 112 and toward the impeller 106. The impeller 106 may impart mechanical energy onto the working fluid and discharge the working fluid to a diffuser passage 114 of the compressor 32. The working fluid may be directed from the diffuser passage 114 to a volute 116 of the compressor 32 and from the volute 116 to a condenser (e.g., the condenser 34) for heat exchange with a fluid, such as a cooling fluid.

In the illustrated embodiment, the compressor 32 (e.g., bearing system 100) includes a first bearing 118 (e.g., a radial bearing, bearing assembly, porous bearing) and a second bearing 120 (e.g., a radial bearing, bearing assembly, porous bearing) configured to control and/or adjust a position (e.g., radial position) of the shaft 104 relative to an axis 122 (e.g., rotational axis, central axis) of the shaft 104. For example, the first bearing 118 and the second bearing 120 may be configured to support a load of the shaft 104, such that the shaft 104 levitates within the first bearing 118 and the second bearing 120. The first bearing 118 and the second bearing 120 may also be configured to block movement (e.g., bending, radial movement, eccentric rotation) of the shaft 104 crosswise to the axis 122. The compressor 32 (e.g., bearing system 100) further includes a third bearing 124 (e.g., thrust bearing, axial bearing, bearing assembly, porous bearing) configured to control and/or adjust a position (e.g., axial position) of the shaft 104 along the axis 122. For example, the third bearing 124 may be configured to block or limit movement (e.g., translation) of the shaft 104 along the axis 122.

As mentioned above, the bearing system 100 is configured to direct a pressurized fluid to bearings of the bearing system 100, such as the first bearing 118, the second bearing 120, and/or the third bearing 124. The pressurized fluid may be the same working fluid (e.g., refrigerant) circulated through the vapor compression system 14 having the compressor 32. However, it should be appreciated that the pressurized fluid may be any suitable fluid, such as a refrigerant, a condensable vapor, or other fluid. In some embodiments, the first bearing 118, the second bearing 120, and/or the third bearing 124 each include one or more porous elements 126 configured to direct the pressurized fluid therethrough. For example, the one or more porous elements 126 of the first bearing 118 and the second bearing 120 may be configured to received pressurized fluid and direct the pressurized fluid towards the shaft 104 to establish a high-pressure fluid film (e.g., vapor film) about the shaft 104 between the first bearing 118 and the second bearing 120 and the shaft 104. In this way, the pressurized fluid may cause the shaft 104 to levitate from the first bearing 118 and the second bearing 120, thereby enabling desired rotation of the shaft 104 about the axis 122. The one or more porous elements 126 of the third bearing 124 may receive pressurized fluid and direct the pressurized fluid towards a collar 128 (e.g., thrust collar) of the third bearing 124. In this way, the pressurized fluid may apply a force to the collar 128 and enable adjustable positioning of the shaft 104 along the axis 122.

The bearing system 100 includes a fluid supply system 130 configured to supply pressurized fluid to the bearings (first bearing 118, second bearing 120, and/or third bearing 124) of the bearing system 100. For example, the fluid supply system 130 may direct the pressurized fluid through the housing 102 of the compressor 32 to one or more bearing housings 132 (e.g., casings) of the first bearing 118, the second bearing 120, and the third bearing 124. In the illustrated embodiment, one bearing housing 132 is associated with the first bearing 118, and another bearing housing 132 is associated with the second bearing 120. An additional bearing housing 132 may be utilized with the third bearing 124. In other embodiments, the second bearing 120 and the third bearing 124 may be packaged together in a common bearing housing 132. The pressurized fluid may be directed through the bearing housings 132 to the corresponding porous elements 126 retained within each bearing housing 132. The fluid supply system 130 is described in further detail below. It should be appreciated that the compressor 32 may include any suitable number or type (e.g., radial, axial) of bearings incorporating the present techniques, and the bearings may be positioned at any suitable location within the housing 102 of the compressor 32.

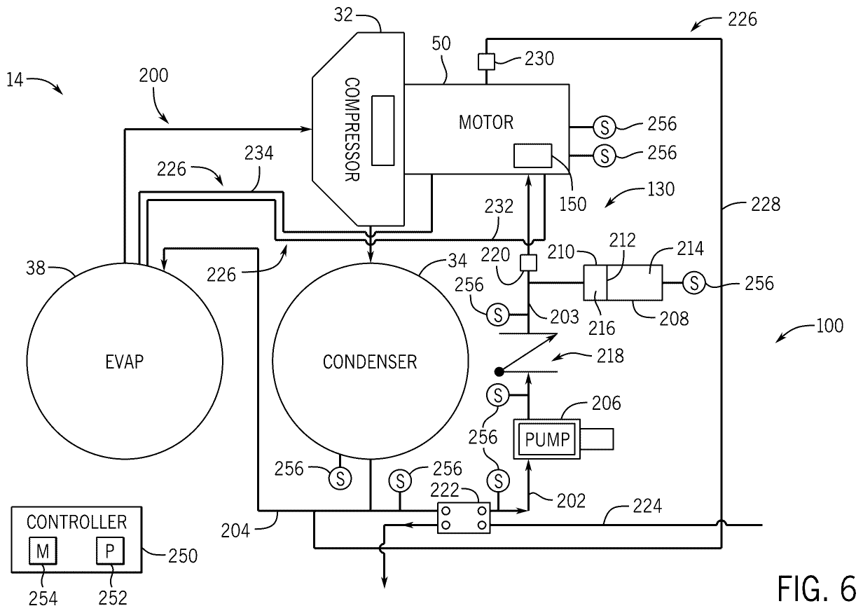

FIG. 6 is a schematic of an embodiment of the vapor compression system 14 (e.g., HVAC&R system) including the bearing system 100 for the compressor 32. The vapor compression system 14 includes elements similar to those discussed above, including the compressor 32, the motor 50, the condenser 34, and the evaporator 38 (e.g., falling film evaporator) arranged along a working fluid circuit 200 (e.g., refrigerant circuit). In accordance with present techniques, the bearing system 100 also includes the fluid supply system 130 configured to direct pressurized fluid to the bearings (e.g., first bearing 118) of the bearing system 100. In particular, the fluid supply system 130 is configured to direct a portion of working fluid (e.g., refrigerant) circulated through the working fluid circuit 200 to one or more bearing assemblies 150 (e.g., first bearing 118, second bearing 120). To this end, the fluid supply system 130 includes a lubricant circuit 202 (e.g., fluid supply circuit) extending from the working fluid circuit 200 to the bearing assemblies 150 via a fluid conduit 203.

In the illustrated embodiment, the lubricant circuit 202 extends from a liquid line portion 204 of the working fluid circuit 200 to the bearing assemblies 150. The liquid line portion 204 extends from the condenser 34 to the evaporator 38. Thus, working fluid within the liquid line portion 204 may be in a liquid phase. Various components are disposed along the lubricant circuit 202 and are configured to enable desirable supply of working fluid to the bearing assemblies 150 to enable the bearing assemblies 150 to support a load of the shaft 104 of the compressor 32. For example, the fluid supply system 130 includes a pump 206 (e.g., liquid pump) disposed along the lubricant circuit 202 and configured to direct flow of working fluid (e.g. liquid working fluid) along the lubricant circuit 202 from the liquid line portion 204 of the working fluid circuit 200 to the bearing assemblies 150 of the motor 50 (e.g., compressor 32). The pump 206 may be a linear piston pump, in some embodiments, and the pump 206 may be driven electrically, pneumatically, mechanically, electromechanically, and/or via another suitable technique. In some embodiments, the pump 206 may operate without utilizing oil or other dedicated lubricant.

The fluid supply system 130 also includes a pressure accumulator 208 fluidly coupled to the lubricant circuit 202. The pressure accumulator 208 is fluidly coupled to the lubricant circuit 202 (e.g., conduit 203) downstream of the pump 206 and/or upstream of the bearing assemblies 150 relative to a flow of working fluid along the lubricant circuit 202. Thus, the pressure accumulator 208 may receive a pressurized flow of working fluid (e.g., liquid working fluid, vapor working fluid, or both) from the pump 206 and the lubricant circuit 202. As will be appreciated, the pressure accumulator 208 is configured to store pressurized working fluid therein. For example, the pressure accumulator 208 may include a vessel 210 and a separator 212 (e.g., bladder, diaphragm, piston, etc.) disposed therein. In some embodiments, the separator 212 may divide an internal volume of the vessel 210 into a biasing chamber 214 (e.g., gas chamber) on a first side of the separator 212 and a fluid chamber 216 (e.g., liquid chamber, working fluid chamber) on a second side the separator 212. The fluid chamber 216 of the pressure accumulator 208 is configured to receive pressurized working fluid from the lubricant circuit 202. The separator 212 may be a bladder or other flexible container pre-charged with a gas (e.g., nitrogen) to enable maintaining the pressure of the working fluid within the fluid chamber 216. In other embodiments, the biasing chamber 214 may be pre-charged with a gas. In still further embodiments, the biasing chamber 214 may instead include a spring or other mechanical biasing component. In any case, the pressure accumulator 208 may operate as a mechanical battery configured to enable supply (e.g., temporary supply) of pressurized working fluid from the fluid chamber 216 to the bearing assemblies 150 via the lubricant circuit 202, such as during periods of non-operation of the pump 206. For example, if the flow of the working fluid in the conduit 203 experiences a change in pressure (e.g., due to an interruption in operation of the pump 206), the pressure accumulator 208 may dispense (e.g., discharge) pressurized working fluid to the lubricant circuit 202 for supply to the bearing assemblies 150. In this way, the bearing assemblies 150 may continue to operate to support a load on the shaft 104 while operation of the pump 206 is restarted and/or while operation of the compressor 32 (e.g., the motor 50) is suspended in a controlled manner. In some embodiments, the pressure accumulator 208 may also operate to regulate (e.g., damp) oscillations in the flow of pressurized working fluid directed to the bearing assemblies 150. Further, the pressure accumulator 208 may be configured to supply pressurized working fluid to the bearing assemblies 150 at startup of the vapor compression system 14 (e.g., prior to operation of the pump 206 and/or the compressor 32). In any case, the pressure accumulator 208 may be configured to regulate the flow of the working fluid based on a pressure of the flow within the conduit 203.

The fluid supply system 130 may also include other components disposed along the lubricant circuit 202, such as a check valve 218 disposed between the pump 206 and the pressure accumulator 208. The check valve 218 may be configured to close and block flow of liquid working fluid from the pump 206 and along toward the bearing assemblies 150 based on a pressure of the liquid working fluid discharged by the pump 206. For example, in response to a pressure of the liquid working fluid falling below a threshold value (e.g., a threshold value corresponding to a liquid working fluid pressure desired for supply to the bearing assemblies 150), the check valve 218 may close. In such instances, pressurized liquid working fluid stored within the pressure accumulator 208 may be supplied to the bearing assemblies 150 (e.g., with the closed check valve 218 blocking working fluid flow back to the pump 206) to enable at least temporary continued operation of the bearing assemblies 150 to support the shaft 104. The check valve 218 may be a ball check valve, a diaphragm check valve, a swing check valve, a stop-check valve, a lift-check valve, an in-line check valve, or any other suitable valve.

In some embodiments, the fluid supply system 130 may include a filter 220 disposed along the lubricant circuit 202 (e.g., downstream of the pressure accumulator 208 and upstream up the bearing assemblies 150). The filter 220 (e.g., may be configured to remove particulates and/or moisture (e.g., water, water vapor) from the liquid working fluid prior to the liquid working fluid being directed to the bearing assemblies 150.

The fluid supply system 130 may also include a heat exchanger 222 disposed along the lubricant circuit 202. The heat exchanger 222 is disposed upstream of the pump 206 relative to flow of working fluid through the lubricant circuit 202. In some embodiments, the heat exchanger 222 may be a brazed-plate heat exchanger. In operation, the heat exchanger 222 may function as a subcooler configured to subcool working fluid directed from the liquid line portion 204 into the lubricant circuit 202. In this way, the heat exchanger 222 may operate to ensure that the working fluid supplied to the pump 206 is in a liquid phase, which may reduce undesired effects, such as flashing of the working fluid at the pump 206, cavitation of the pump 206, and so forth. The heat exchanger 222 is configured to place the working fluid drawn from the liquid line portion 204 in a heat exchange relationship with a cooling fluid (e.g., auxiliary cooling fluid) directed to the heat exchanger 222 via a cooling fluid circuit 224. The cooling fluid may be water, in some embodiments. In such embodiments, the cooling fluid circuit 224 may be configured to supply the cooling fluid from an external source. Additionally or alternatively, the cooling fluid circuit 224 may be configured to supply water or other cooling fluid (e.g., cooled via the evaporator 38) from a conditioning fluid conduit, such as the supply line 60S and/or the return line 60R described above. In some embodiments, the cooling fluid may be another portion of working fluid from the working fluid circuit 200. In such embodiments, the cooling fluid circuit 224 may extend from the working fluid circuit 200 (e.g., the liquid line portion 204) to the heat exchanger 222. However, it should be appreciated that the cooling fluid circuit 224 may be configured to direct any suitable cooling fluid to the heat exchanger 222 to enable cooling (e.g., subcooling) of the portion of the working fluid directed along the lubricant circuit 202 toward the bearing assemblies 150 of the compressor 32.

As mentioned above, the bearing assemblies 150 are configured to receive pressurized fluid (e.g., working fluid, refrigerant) and to discharge the fluid towards the shaft 104 or collar 128. In particular, the bearing assemblies 150 each include one or more porous elements configured to direct the pressurized working fluid therethrough and to flash the pressurized working fluid and discharge pressurized vapor working fluid towards the shaft 104 or collar 128. Thereafter, the working fluid may flow through the housing 102 of the compressor 32 (e.g., motor 50) to one or more drain lines 226 of the bearing system 100. For example, the bearing system 100 may include a first drain line 228 extending from the housing 102 to the liquid line portion 204 of the working fluid circuit 200. The first drain line 228 may include a valve 230 (e.g., electronic expansion valve) and/or may be configured to direct vapor working fluid from the housing 102 to the liquid line portion 204 of the working fluid circuit 200. Additionally or alternatively, the bearing system 100 may include a second drain line 232 extending from the housing 102 to the evaporator 38 and/or a third drain line 234 extending from the housing 102 to the evaporator 38. In some embodiments, the second drain line 232 is configured to direct vapor working fluid from the housing 102 to the evaporator 38, and the third drain line 234 is configured to direct liquid working fluid from the housing 102 to the evaporator 38.

The vapor compression system 14 may also include a controller 250 (e.g., a control system, control board, control panel) communicatively coupled to one or more components of the vapor compression system 14 and/or the bearing system 100. The controller 250 is configured to monitor, adjust, and/or otherwise control operation of the components of the vapor compression system 14 and/or the bearing system 100. For example, one or more control transfer devices, such as wires, cables, wireless communication devices, and the like, may communicatively couple the compressor 32, the motor 50, the pump 206, and/or other components described herein. Such components may include a network interface that enables the components of the vapor compression system 14 and/or bearing system 100 to communicate via various protocols such as EtherNet/IP, ControlNet, DeviceNet, or any other communication network protocol. Alternatively, the communication component may enable the components of the vapor compression system 14 and/or bearing system 100 to communicate via mobile telecommunications technology, Bluetooth®, near-field communications technology, and the like.

In some embodiments, the controller 250 may include a portion or all of the control panel 40 or may be another suitable controller included in the vapor compression system 14 and/or the bearing system 100. In any case, the controller 250 may be configured to control components of the vapor compression system 14 and/or the bearing system 100 in accordance with the techniques discussed herein. The controller 250 includes processing circuitry 252, such as one or more microprocessors, which may execute software for controlling the components of the vapor compression system 14 and/or the bearing system 100. The processing circuitry 252 may include multiple microprocessors, one or more “general-purpose” microprocessors, one or more special-purpose microprocessors, and/or one or more application specific integrated circuits (ASICS), or some combination thereof. For example, the processing circuitry 252 may include one or more reduced instruction set (RISC) processors.

The controller 250 may also include a memory device 254 (e.g., a memory) that may store information such as instructions, control software, look up tables, configuration data, etc. The memory device 254 may include a volatile memory, such as random access memory (RAM), and/or a nonvolatile memory, such as read-only memory (ROM). The memory device 254 may store a variety of information and may be used for various purposes. For example, the memory device 254 may store processor-executable instructions including firmware or software for the processing circuitry 252 to execute, such as instructions for controlling components of the vapor compression system 14 and/or the bearing system 100. In some embodiments, the memory device 254 is a tangible, non-transitory, machine-readable-medium that may store machine-readable instructions for the processing circuitry 252 to execute. The memory device 254 may include ROM, flash memory, a hard drive, or any other suitable optical, magnetic, or solid-state storage medium, or a combination thereof. The memory device 254 may store data, instructions, and any other suitable data. It should be appreciated that the memory device 254 may store processor-executable instructions (e.g., for executing via the processing circuitry 252) to control any of the components described herein to enable any or all of the operations and/or functionalities described herein.

The controller 250 may be configured to control operation of components of the vapor compression system 14 and/or the bearing system 100 based on detected operating parameters of the vapor compression system 14 and/or the bearing system 100. To this end, the vapor compression system 14 includes one or more sensors 256 configured to detect operating parameters associated with or indicative of operating conditions of the vapor compression system 14 and the bearing system 100. For example, one or more of the sensors 256 may be disposed along the lubricant circuit 202 and may be configured to detect operating parameters of the refrigerant directed through the lubricant circuit 202, such as temperature, pressure, flow rate, and so forth. In some embodiments, one or more sensors 256 may be configured to detect an operating parameter associated with the motor 50, such as a rotational speed of the shaft 104, a torque on the shaft 104, a temperature of the motor 50, and so forth. One or more sensors 256 may be configured to detect an operating parameter of the bearing assemblies 150, such as a detection of whether one or more bearing assemblies 150 is in contact (e.g., physical contact) with the shaft 104, as described further below.

In some embodiments, one of the sensors 256 may be configured to detect an operating parameter associated with the pressure accumulator 208, such as a pressure of refrigerant within the fluid chamber 216 and/or a pressure of gas within the biasing chamber 214. Additionally or alternatively, one or more of the sensors 256 may be configured to detect a liquid level of working fluid within the condenser 34, which may be referenced before and/or during startup of the bearing system 100 and/or vapor compression system 14. As will be appreciated, each sensor 256 included in the vapor compression system 14 may be communicatively coupled to the controller 250. Thus, the controller 250 may receive data and/or feedback from the sensors 256 and may control operation of the vapor compression system 14 and/or the bearing system 100 based on the feedback and/or data.

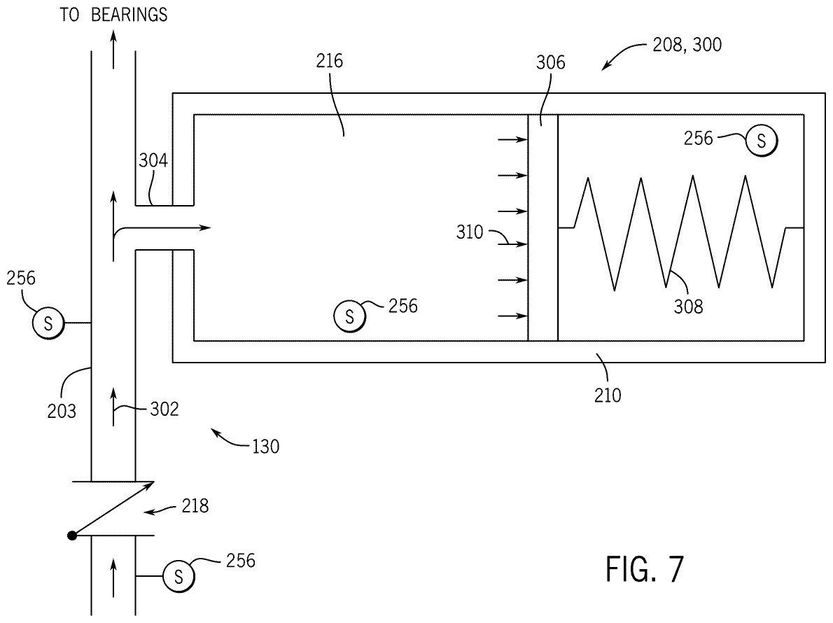

FIG. 7 is a schematic of an embodiment of the pressure accumulator 208, illustrating the pressure accumulator 208 as a spring-loaded piston accumulator 300. As discussed above, the fluid conduit 203 transports a pressurized flow 302 of working fluid from the pump 206 to the bearing system 100. A fluid port 304 of the spring-loaded piston accumulator 300 may be fluidly coupled to the fluid conduit 203, such that the spring-loaded piston accumulator 300 is configured to receive a portion of the pressurized flow 302 of working fluid. The spring-loaded piston accumulator 300 includes a piston 306 driven by a spring 308. The piston 306 and the spring 308 are disposed within the vessel 210 of the accumulator 208. The spring 308 applies a spring force to one side of the piston 306 to balance the piston 306 against a fluid pressure 310 of the working fluid acting on the other (e.g., opposite) side of the piston 306. As such, the fluid pressure 310 may act against the piston 306 to compress the spring 308 as working fluid enters the fluid chamber 216. In this way, the spring-loaded piston accumulator 300 may store the working fluid within the fluid chamber 216 while the spring 308 and the piston 306 apply a balancing pressure to the stored working fluid within the fluid chamber 216.

In some situations, the pressurized flow 302 of working fluid through the check valve 218 may fall below a threshold or desired pressure level. For example, operation of the pump 206 may be interrupted (e.g., due to a loss of electrical power), the fluid conduit 203 may experience a blockage or leakage upstream of the spring-loaded piston accumulator 300, or the pressurized flow 302 may be reduced or stopped by a valve (e.g., an emergency shut-off valve) upstream of the check valve 218. In order to temporarily maintain the supply of pressurized working fluid to the bearings of the bearing system 100, the pressure accumulator 208 may discharge the pressurized working fluid stored in the fluid chamber 216 to the fluid conduit 203 and toward the bearings. In particular, the force of the spring 308 acting upon the piston 306 may cause the spring-loaded piston accumulator 300 to expel the stored working fluid from the fluid chamber 216 to the fluid conduit 203 (e.g., via the fluid port 304). In this way, the pressure accumulator 208 may maintain the supply of pressurized working fluid to the bearings until the lubricant circuit 202 (e.g., fluid supply system 130) returns to normal operation and/or until the compressor 32 (e.g., the shaft 104) comes to a stop.

In response to the loss of pressure (e.g., within the fluid conduit 203, within the fluid chamber 216), the check valve 218 may close to block working fluid discharged from the pressure accumulator 208 from traveling upstream toward the pump 206. In some embodiments, pressure on the upstream side of the check valve 218 must be greater than pressure on the downstream side of the check valve 218 in order for the check valve 218 to open and enable the pressurized flow 302 of working fluid to flow therethrough. For example, the check valve 218 may be a swing check valve configured to allow fluid to flow therethrough in response to the pressure (e.g., pressure differential) of the flow in the downstream direction being above a threshold pressure (e.g., cracking pressure). Alternatively, the sensors 256 may detect that the pressure upstream of the check valve 218, downstream of the check valve 218, and/or in the fluid chamber 216 is lower than a threshold pressure. Then, the controller 250 may instruct the check valve 218 to close, thereby avoiding backflow of the working fluid. In some embodiments, the check valve 218 may be configured to close in response to detection of a back pressure across the check valve 218.

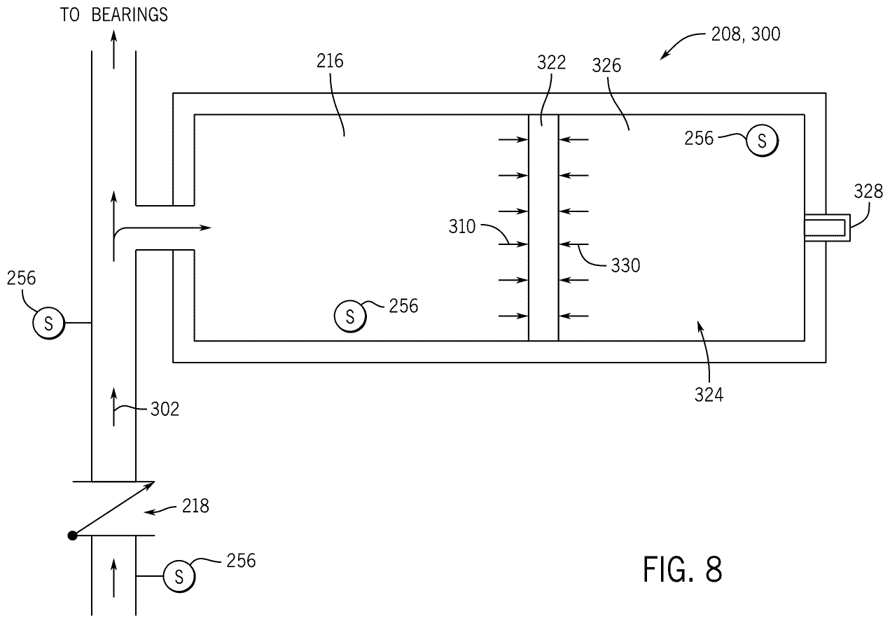

FIG. 8 is a schematic of an embodiment of the pressure accumulator 208, illustrating the pressure accumulator 208 as a gas-charged piston accumulator 320. Like the spring-loaded piston accumulator 300 discussed above with reference to FIG. 7, the gas-charged piston accumulator 320 includes a piston 322 configured to apply a balancing pressure against the fluid pressure 310 of the working fluid inside the fluid chamber 216. The gas-charged piston accumulator 320 includes a gas chamber 324 (e.g., biasing chamber 214) on a side of the piston 322 opposite the fluid chamber 216. Pressurized gas 326 (e.g., a gas charge, inert gas, pre-charged gas, nitrogen) may be introduced to the gas chamber 324 via a charging valve 328 fluidly coupled to the gas chamber 324. For example, the gas chamber 324 may be loaded with nitrogen at a desired pressure prior to operation of the gas-charged piston accumulator 320. The gas 326 in the gas chamber 324 exerts a gas pressure 330 on the piston 330, which acts or biases against the fluid pressure 310 exerted by the working fluid. During normal operation, the gas pressure 330 and the fluid pressure 310 may be balanced, such that the piston 322 is at an equilibrium position. However, if the fluid pressure 310 drops (e.g., during an interruption of operation of the pump 206), then the check valve 218 may close, and the gas pressure 330 may push the piston 322 to discharge the working fluid from the fluid chamber 216 to maintain the pressurized flow 302 of the working fluid to the bearings.

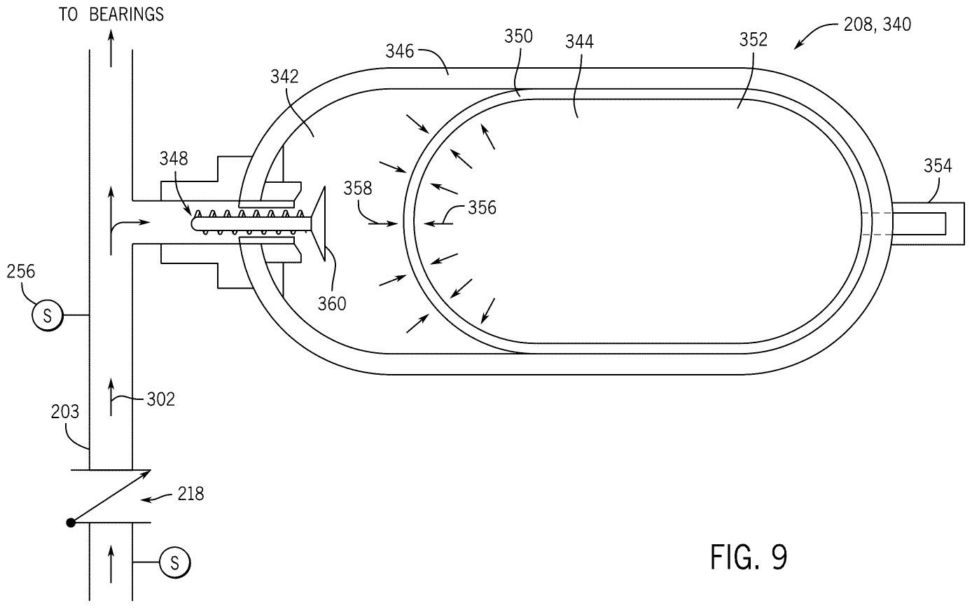

FIG. 9 is a schematic of the pressure accumulator 208, illustrating the pressure accumulator 208 as a bladder accumulator 340. The bladder accumulator 340 includes a fluid chamber 342 and a bladder 344 housed within a vessel 346. The fluid chamber 346 is fluidly coupled to the fluid conduit 203 via a fluid port 348, such that the pressurized flow 302 of working fluid may enter the fluid chamber 342 via the fluid port 348. The bladder 344 may be a gas chamber having one or more walls 350 formed from an elastomeric material. The shape and/or volume of the bladder 344 may change in response to a pressure differential across the walls 350 (e.g., between the inside and the outside) of the bladder 344. A pressurized gas 352 may be introduced to the bladder 344 via a charging port 354 to achieve a pre-charged state of the bladder 344 prior to operation of the bladder accumulator 340. The pressurized gas 352 exerts a gas pressure 356 against the walls 350 of the bladder 344, causing the bladder 344 to expand into the fluid chamber 342. In the pre-charged state, the bladder 344 may expand to completely fill the vessel 346 (e.g., occupy substantially an entire volume of the vessel 346). When the bladder accumulator 340 is fluidly coupled to the fluid conduit 203, the pressurized flow 302 of working fluid may enter the fluid chamber 342 via the fluid port 348 and exert a fluid pressure 358 against the walls 350 of the bladder 344, causing the bladder to contract. In this way, the respective volumes of the bladder 344 and the fluid chamber 342 may vary depending on the pressure of the pressurized gas 352 and the working fluid within the fluid chamber 342.

During normal operation, working fluid may accumulate in the fluid chamber 342 at a pressure corresponding to the pressure of the pressurized flow 302 of working fluid directed to the bearings. As a result, the bladder 344 may store the gas pressure 356 in a contracted state as the fluid pressure 358 acts on the walls 350 of the bladder 344. Thus, the shape and volume of the bladder 356 may be at equilibrium with the fluid chamber 342. However, if the fluid pressure 358 drops (e.g., during an interruption of operation of the pump 206), the check valve 218 may close, and the gas pressure 356 may cause the bladder 344 to expand, thereby discharging the working fluid from the fluid chamber 342 to maintain the pressurized flow 302 of the working fluid to the bearings.

In some embodiments, the bladder accumulator 340 may include a poppet valve 360 at the fluid port 348. The poppet valve 360 may be biased (e.g., spring-loaded) toward an open position to enable the working fluid to flow in and out of the fluid chamber 342. When the bladder 344 is in a fully expanded state (e.g., pre-charged), the bladder 344 may abut and bias against the poppet valve 360, thereby closing the poppet valve 260 and blocking the bladder 344 from extruding out of the fluid port 348 and into the fluid conduit 203.

As the bladder 344 expands to supply backup pressure to the working fluid, the gas pressure 356 may decrease. Therefore, the pressure of the working fluid supplied to the bearings from the bladder accumulator 340 may decrease over time. It may be desirable to maintain a relatively constant pressure of the working fluid discharged from the bladder 344. To this end, the bladder accumulator 340 may be fluidly coupled to a fluid supply source (e.g., gas supply source).

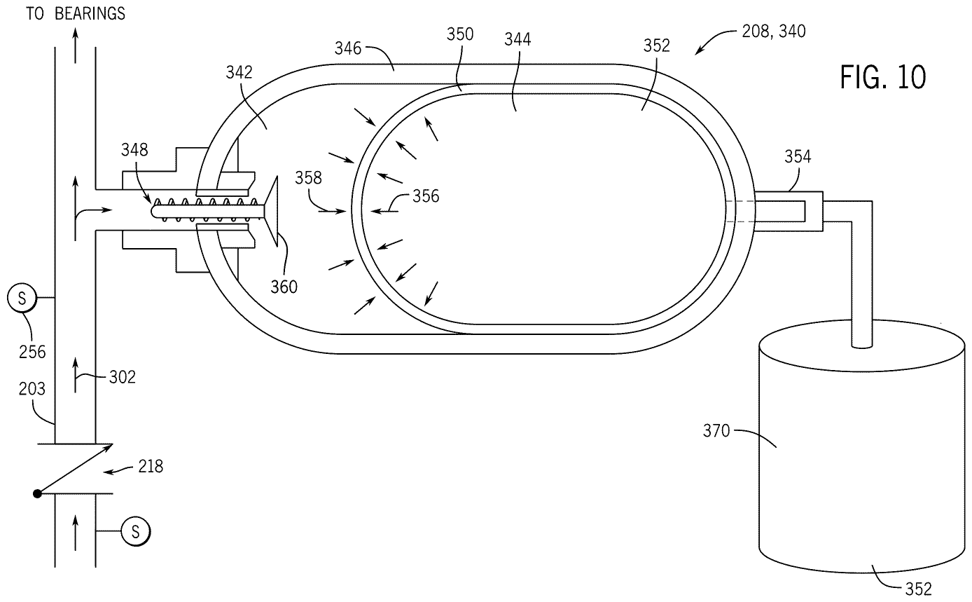

For example, FIG. 10 is a schematic of an embodiment of the bladder accumulator 340, illustrating the bladder accumulator 340 coupled to a fluid source 370 (e.g., gas source, gas tank, gas reservoir). The fluid source 370 is configured to introduce gas 352 into the bladder 344 (e.g., into the internal volume defined by the walls 350) to keep the gas pressure 356 elevated during expansion of the bladder 344 (e.g., during discharge of working fluid from the bladder accumulator 304). Because the change in volume of the bladder 344 may be relatively small compared to the combined volume of the vessel 346 and the fluid source 370 (e.g., gas tank), the gas pressure 356 may remain relatively constant as the bladder 344 expands. In this way, the pressure of the working fluid supplied to the bearings from the bladder accumulator 340 may be relatively constant throughout the expansion of the bladder 344.

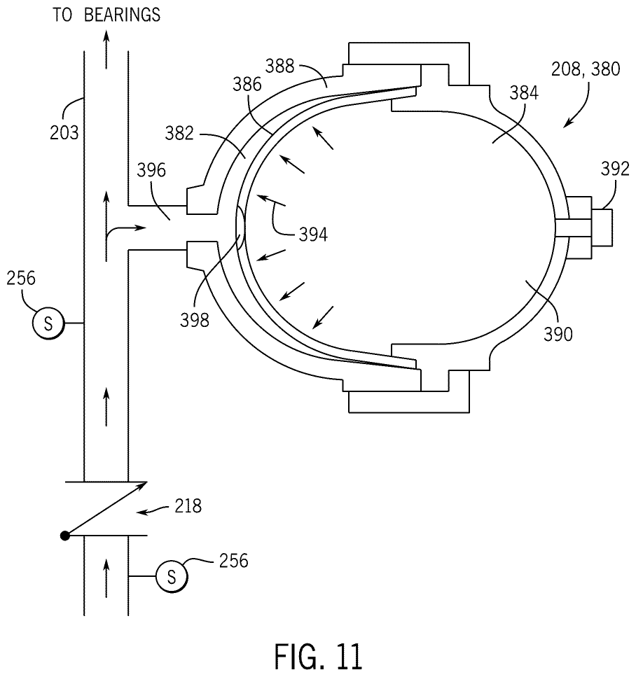

FIG. 11 is a schematic of an embodiment of the pressure accumulator 208, illustrating the pressure accumulator 208 as a diaphragm accumulator 380. The diaphragm accumulator 380 includes a fluid chamber 382 and a gas chamber 384 housed within a vessel 388 and partitioned by a diaphragm 386. The diaphragm 386 may be formed from an elastomeric material (e.g., rubber) and be configured to bulge toward one or both of the fluid chamber 382 or the gas chamber 384 based on a pressure differential between the chambers 382, 384. For example, pressurized gas 390 may be introduced to the gas chamber 384 via a charging port 392 to achieve a pre-charged state prior to operation of the diaphragm accumulator 340. The pressurized gas 390 may exert a gas pressure 394 against the diaphragm 386, thereby causing the diaphragm 386 to expand toward the fluid chamber 382. Accordingly, the volume of the gas chamber 284 may increase, and the volume of the fluid chamber 382 may decrease. In the pre-charged state, the diaphragm 386 may extend to completely occlude the fluid chamber 382. When the diaphragm accumulator 380 is fluidly coupled to the fluid conduit 203, the pressurized flow 302 of working fluid may enter the fluid chamber 382 via a fluid port 396 and exert a fluid pressure against the diaphragm 386, causing the fluid chamber 382 to expand and the gas chamber 384 to contract.

During normal operation, the working fluid may accumulate in the fluid chamber 382 at a fluid pressure corresponding to the pressure of the pressurized flow 302 of working fluid. As a result, the diaphragm accumulator 380 may store a pressure differential across the diaphragm 386. In some instances, the shape and volume of the gas chamber 384 may be at equilibrium with the fluid chamber 382. However, if the fluid pressure drops (e.g., during an interruption of operation of the pump 206), then the check valve 218 may close, and the gas pressure 394 may cause the diaphragm 386 to bulge toward the fluid port 396, thereby discharging the working fluid from the fluid chamber 382 to maintain the pressurized flow 302 of the working fluid to the bearings. To block the diaphragm 386 from extruding out of the vessel 388, the diaphragm accumulator 380 may include a button 398 on the diaphragm 386 or a poppet valve at the fluid port to block the fluid port during expansion and/or actuation of the diaphragm 386.

In addition to providing a backup source of pressurized working fluid in the event of an interruption to normal operation to the fluid supply system 130, the pressure accumulator 208 may regulate the flow of pressurized working fluid during normal operation. For example, the pressure of the working fluid upstream of the pressure accumulator 208 may undesirably fluctuate (e.g., due to pump cycles) and/or surge. The pressure accumulator 208 may buffer the fluctuations by storing and releasing pressurized working fluid in coordination with changes in the pressure of the working fluid entering the fluid chamber 216. As such, the pressure accumulator 208 may function as a mechanical capacitor, smoothing oscillations in energy within a conduit and thereby providing more consistent pressurized flow of working fluid to the bearings.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A heating, ventilation, air conditioning, and/or refrigeration (HVAC&R) system, comprising:
a compressor comprising a bearing;
a lubricant circuit configured to direct a flow of a fluid to the bearing; and
a pressure accumulator fluidly coupled to the lubricant circuit upstream of the bearing, wherein the pressure accumulator is configured to receive and contain a portion of the fluid from the lubricant circuit.

2. The HVAC&R system of claim 1, wherein the pressure accumulator is configured to apply a force to the portion of the fluid and to regulate a pressure of the flow of the fluid in the lubricant circuit.

3. The HVAC&R system of claim 1, wherein the pressure accumulator is configured to supply the portion of the fluid to the bearing in response to a pressure drop in the flow of the fluid in the lubricant circuit.

4. The HVAC&R system of claim 1, wherein the pressure accumulator comprises:
a fluid chamber configured to receive and contain the portion of the fluid; and
a biasing chamber configured to apply a force to the portion of the fluid.

5. The HVAC&R system of claim 4, wherein pressure accumulator comprises a separator dividing the fluid chamber and the biasing chamber, wherein the biasing chamber is configured to contain a pressurized gas, and the pressurized gas is configured to exert the force against the separator.

6. The HVAC&R system of claim 1, wherein the pressure accumulator comprises a piston configured to apply a force to the portion of the fluid within the pressure accumulator.

7. The HVAC&R system of claim 1, comprising:
a pump disposed along the lubricant circuit, wherein the pump is configured to pump the flow of the fluid toward the bearing; and
a check valve disposed along the lubricant circuit between the pump and the pressure accumulator.

8. The HVAC&R system of claim 7, wherein the pressure accumulator is configured to supply the portion of the fluid to the bearing in response to an interruption in operation of the pump.

9. The HVAC&R system of claim 1, wherein the compressor is configured to circulate a working fluid through a working fluid circuit of the HVAC&R system, and the lubricant circuit is configured to direct a portion of the working fluid from the working fluid circuit to the bearing as the flow of the fluid.

10. A heating, ventilation, air conditioning, and/or refrigeration (HVAC&R) system, comprising:
a compressor comprising a bearing;
a conduit configured to direct a pressurized flow of a fluid to the bearing; and
a pressure accumulator fluidly coupled to the conduit, wherein the pressure accumulator is configured to apply a force to the fluid within the conduit based on a change in pressure of the fluid within the conduit.

11. The HVAC&R system of claim 10, comprising a pump configured to drive the pressurized flow of the fluid through the conduit, wherein the pump is disposed along the conduit, and the pressure accumulator is disposed between the pump and the bearing.

12. The HVAC&R system of claim 11, wherein the pressure accumulator is configured to at least partially drive the pressurized flow of the fluid to the bearing in response to an interruption in operation of the pump.

13. The HVAC&R system of claim 11, wherein the pressure accumulator is configured to receive a portion of the pressurized flow of the fluid from the conduit and to store the portion of the pressurized flow of the fluid within the pressure accumulator during operation of the pump.

14. The HVAC&R system of claim 10, wherein the pressure accumulator comprises:
a fluid chamber configured to receive a portion of the pressurized flow of the fluid from the conduit; and
a biasing chamber configured to apply a force to the portion of the pressurized flow of the fluid based on a pressure of the portion of the pressurized flow of the fluid in the fluid chamber.

15. The HVAC&R system of claim 14, wherein the biasing chamber comprises a bladder containing a pressurized gas, and the bladder is configured to expand based on the pressure of the portion of pressurized fluid in the fluid chamber.

16. The HVAC&R system of claim 14, comprising a gas reservoir coupled to the pressure accumulator, wherein the gas reservoir is configured to supply a pressurized gas to the biasing chamber.

17. The HVAC&R system of claim 10, wherein the compressor is configured to circulate a working fluid through a working fluid circuit of the HVAC&R system, and the pressurized flow of the fluid comprises a portion of the working fluid.

18. A heating, ventilation, air conditioning, and/or refrigeration (HVAC&R) system, comprising:
a compressor configured to pressurize a working fluid and circulate the working fluid through a working fluid circuit of the HVAC&R system, wherein the compressor comprises a bearing;
a lubricant circuit extending from the working fluid circuit to the bearing;
a pump disposed along the working fluid circuit and configured to direct a portion of the working fluid to the bearing; and
a pressure accumulator fluidly coupled to the lubricant circuit, wherein the pressure accumulator is configured to store a pressurized volume of the working fluid.

19. The HVAC&R system of claim 18, wherein the pressure accumulator is configured to supply the pressurized volume of the working fluid to the bearing in response to a change in pressure of the portion of the working fluid within the lubricant circuit.

20. The HVAC&R system of claim 18, wherein the pressure accumulator comprises a diaphragm configured to apply a force to the pressurized volume of the working fluid.
